(19) United States
(12) Patent Application Publication
(10) Pub. No.: US 2013/0314077 A1
(43) Pub. Date: Nov. 28, 2013

(54) DISPLACEMENT MEASUREMENT DEVICE

(71) Applicant: PANASONIC CORPORATION, Osaka (JP)

(72) Inventors: Kunitaka OKADA, Osaka (JP); Masahisa NIWA, Osaka (JP)

(73) Assignee: PANASONIC CORPORATION, Osaka (JP)

(21) Appl. No.: 13/902,569

(22) Filed: May 24, 2013

(30) Foreign Application Priority Data
May 25, 2012 (JP) 2012-120029

(51) Int. Cl. G01B 7/14

(52) U.S. Cl. CPC G01B 7/14
USPC 324/207.12

(57) ABSTRACT

The displacement measurement device according to the present invention includes: a metal object movable in a moving direction within a moving plane; a measurement coil arranged such that an opposite area of a measurement coil surface opposite to the moving plane is varied with a movement of the metal object; and a correction coil arranged such that an opposite area of a correction coil surface to the moving plane is not varied irrespective of the movement of the metal object. The measurement coil and the correction coil are arranged such that the measurement coil surface and the correction coil surface are not overlapped with each other with regard to a plane parallel to the moving plane but a range occupied by the measurement coil in a coordinate axis along the moving direction and a range occupied by the correction coil in the coordinate axis are overlapped with each other.

### TECHNICAL FIELD

The present invention relates to a displacement measurement device for measuring a displacement of a metal object.

### BACKGROUND ART

In the past, there has been proposed a displacement measurement device for measuring a displacement of a metal object in a contactless manner.

For example, there has been a displacement measurement device which includes a measurement coil formed into a cylindrical shape and is configured to measure a metal object movable in an axial direction of the measurement coil (e.g., see document 1 [JP 2008-292376 A]). This displacement measurement device measures the displacement based on a phenomenon in which an inductance of the measurement coil is changed with a movement of the metal object. So, the displacement measurement device measures a change in the inductance and outputs a displacement signal according to a relative position of the metal object to the measurement coil.

Further, there has been proposed a measurement coil which is constituted by a patterned circuit formed on a printed substrate (e.g., see document 2 [JP 2011-112555 A]). In this case, with forming the metal object serving as a detection object into a flat plate shape, the displacement measurement device can be thinned

With regard to such a displacement measurement device which measures the displacement of the metal object by use of a change in the inductance of the measurement coil, the inductance of the measurement coil is susceptible to a gap length between the measurement coil and the metal object. Therefore, it is desirable that the gap length between the measurement coil and the metal object be kept constant. However, components (e.g., a displacement means for moving the metal object) of the displacement detection device will suffer from an aged deterioration (e.g., wear). Accordingly, the gap length may be varied due to such an aged deterioration, and such a variation in the gap length causes an output error in the displacement signal.

To reduce the output error in the displacement signal even if the gap length between the measurement coil and the metal object is varied, there has been proposed a displacement measurement device including a measurement coil 101, a correction coil 102, and a transmitting coil 200 as shown in FIG. 21 (e.g., see document 3 [JP 6-265302 A]).

The transmitting coil 200 is oscillated by an oscillator 210. The correction coil 102 is placed inside the measurement coil 101. A signal processor 110 determines a position of a metal object M100 based on detection principles utilizing electromagnetic induction between the transmitting coil 200 and the measurement coil 101 and electromagnetic induction between the transmitting coil 200 and the correction coil 102. In this case, the measurement coil 101 is used for determining the position of the metal object M1, and the correction coil 102 is used for determining the gap length. The signal processor 110 corrects the displacement signal created by use of the measurement coil 101 according to the gap length determined by use of the correction coil 102.

However, the configuration disclosed in document 3 has the following problems.

FIG. 22 shows the arrangement of the measurement coil 101, the correction coil 102, and the metal object M100. The correction coil 102 is placed inside the measurement coil 101, and the correction coil 102 is positioned close to one end of the measurement coil 101. The metal object M100 is arranged opposite to the measurement coil 101 and is movable in an opposite ends direction of the measurement coil 101. The measurement coil 101 has a coil surface, and an opposite area of the coil surface to the metal object M100 is varied with an amount of the movement (displacement) of the metal object M100. In contrast, the correction coil 102 has a coil surface, and it is necessary that an opposite area of the coil surface to the metal object M100 be kept constant irrespective of the amount of the movement (displacement) of the metal object M100.

Accordingly, as shown in FIG. 22, a coil length W101 of the measurement coil 101 need be greater than the sum of a coil length W102 of the correction coil 102 and a maximum detection length W103 which is defined as a maximum of the amount of the movement of the metal object M101 (i.e., W101>W102+W103). As a result, a detection unit 100 constituted by the measurement coil 101 and the correction coil 102 has a long shape in a moving direction of the metal object M101. This causes an increase in a size of the displacement measurement device with regard to the moving direction of the metal object M101.

With downsizing the correction coil 102, it is possible to shorten the coil length W102 of the correction coil 102. However, when the correction coil 102 is downsized, a magnetic field distribution caused by the correction coil 102 is narrowed, and therefore detection accuracy is likely to be lowered.

### SUMMARY OF INVENTION

In view of the above insufficiency, the present invention has aimed to propose a displacement measurement device which can reduce a detection error due to a variation in a gap between the measurement coil and the metal object and can be downsized in a direction extending along a moving direction of the metal object.

The displacement measurement device of the first aspect in accordance with the present invention includes: a metal object arranged movable in a predetermined moving direction within a predetermined moving plane; a measurement coil having a measurement coil surface opposite to the moving plane and arranged such that an opposite area of the measurement coil surface to the moving plane is varied with a movement of the metal object; a correction coil having a correction coil surface opposite to the moving plane and arranged such that an opposite area of the correction coil surface to the moving plane is not varied irrespective of the movement of the metal object; an inductance detection circuit configured to measure respective inductances of the measurement coil and the correction coil; and a calculation circuit configured to create a displacement signal according to a relative position of the metal object relative to the measurement coil by use of a measurement result from the inductance detection circuit. The measurement coil and the correction coil are arranged such that the measurement coil surface and the correction coil surface are not overlapped with each other with regard to a plane parallel to the moving plane but a range occupied by the measurement coil in a coordinate axis extending along the moving direction and a range occupied by the correction coil in the coordinate axis are overlapped with each other.

As for the displacement measurement device of the second aspect in accordance with the present invention, in addition to the first aspect, the correction coil includes a first correction coil and a second correction coil which are electrically connected with each other. The first correction coil and the second correction coil are arranged in a direction respectively perpendicular to a normal direction of the moving plane and the moving direction. The measurement coil is interposed between the first correction coil and the second correction coil.

As for the displacement measurement device of the third aspect in accordance with the present invention, in addition to the first aspect, the measurement coil includes a first measurement coil and a second measurement coil which are electrically connected with each other. The first measurement coil and the second measurement coil are arranged in a direction respectively perpendicular to a normal direction of the moving plane and the moving direction. The correction coil is interposed between the first measurement coil and the second measurement coil.

As for the displacement measurement device of the fourth aspect in accordance with the present invention, in addition to the first aspect, the metal object includes a first metal object and a second metal object which are arranged opposite to each other. The measurement coil and the correction coil are interposed between the first metal object and the second metal object.

As for the displacement measurement device of the fifth aspect in accordance with the present invention, in addition to any one of the first to fourth aspects, the inductance detection circuit is constituted by a single inductance detection circuit which is configured to measure the inductances of the measurement coil and the correction coil. The displacement measurement device further comprises a switch configured to select a destination for an input of the inductance detection circuit from the measurement coil and the correction coil.

As for the displacement measurement device of the sixth aspect in accordance with the present invention, in addition to any one of the first to fifth aspects, the measurement coil and the correction coil are defined as patterned circuits which are formed on the same substrate.

As for the displacement measurement device of the seventh aspect in accordance with the present invention, in addition to any one of the first to sixth aspects, the inductance detection circuit includes: capacitors connected in parallel with the measurement coil and the correction coil, respectively; an oscillator configured to oscillate an resonance circuit of the measurement coil and the capacitor connected to the measurement coil and an resonance circuit of the correction coil and the capacitor connected to the correction coil; an amplitude detector configured to measure oscillation voltages of the respective resonance circuits; a comparison unit configured to compare the oscillation voltage measured by the amplitude detector with a reference voltage; a conductance controller configured to adjust negative conductance of the oscillator based on a comparison result from the comparison unit such that the oscillation voltage is equal to the reference voltage; and inductance detector configured to measure the inductances of the measurement coil and the correction coil based on an adjustment result of the negative conductance from the conductance controller.

As for the displacement measurement device of the eighth aspect in accordance with the present invention, in addition to any one of the first to seventh aspects, the calculation circuit is configured to, based on the measurement result from the inductance detection circuit, generate the displacement signal by means of multiplying the inductance of the measurement coil by a gain and modify the gain according to the inductance of the correction coil.

As for the displacement measurement device of the ninth aspect in accordance with the present invention, in addition to any one of the first to eighth aspects, the displacement measurement device further comprises a temperature detection circuit configured to measure a temperature of the displacement measurement device or an ambient temperature of the displacement measurement device. The calculation circuit is configured to perform a correction process of the displacement signal based on a measurement result from the temperature detection circuit.

As for the displacement measurement device of the tenth aspect in accordance with the present invention, in addition to any one of the first to ninth aspects, the correction coil is closer to the moving plane of the metal object than the measurement coil is.

### BRIEF DESCRIPTION OF THE DRAWINGS

FIG. 1 is a plane view illustrating a coil configuration of the displacement measurement device of the first embodiment,

FIG. 2 is a plane view illustrating the coil configuration of the displacement measurement device of the first embodiment,

FIG. 3 is a side view illustrating gap lengths of the displacement measurement device of the first embodiment,

FIG. 4 is a block diagram illustrating a circuit configuration of the displacement measurement device of the first embodiment,

FIG. 5 is a graph illustrating a relation between the gap length and a displacement signal of the displacement measurement device of the first embodiment,

FIG. 6 is a plane view illustrating another coil configuration of the displacement measurement device of the first embodiment,

FIG. 7 is a plane view illustrating a planar coil used in the displacement measurement device of the first embodiment,

FIG. 8 is a graph illustrating a relation between a temperature and a coil inductance of the displacement measurement device of the first embodiment,

FIG. 9 is a plane view illustrating a positional relation between a measurement coil and a correction coil of the displacement measurement device of the first embodiment,

FIG. 10 is a plane view illustrating another positional relation between the measurement coil and the correction coil of the displacement measurement device of the first embodiment,

FIG. 11 is a plane view illustrating a coil surface of a planar coil used in the displacement measurement device of the first embodiment,

FIG. 12 is a plane view illustrating a coil surface of a winding coil used in the displacement measurement device of the first embodiment,

FIG. 13 is a side view illustrating the above winding coil,

FIG. 14 is a plane view illustrating the coil configuration of the displacement measurement device of the second embodiment,

FIG. 15 is a plane view illustrating the coil configuration of the displacement measurement device of the third embodiment,

FIG. 16 is a perspective view illustrating the metal object and the coils of the displacement measurement device of the fourth embodiment,

FIG. 17 is a block diagram illustrating the circuit configuration of the displacement measurement device of the fifth embodiment,

FIG. 18 is a block diagram illustrating the circuit configuration of an inductance detection circuit of the displacement measurement device of the sixth embodiment,

FIG. 19 is a circuit diagram illustrating the concrete example of the inductance detection circuit of the displacement measurement device of the sixth embodiment,

FIG. 20 is a side view illustrating the coil configuration of the displacement measurement device of the seventh embodiment,

FIG. 21 is a block diagram illustrating the circuit configuration of a prior displacement measurement device, and

FIG. 22 is a plane view illustrating the coil configuration of the prior displacement measurement device.

### DESCRIPTION OF EMBODIMENTS

### First Embodiment

FIG. 4 shows a block configuration of the displacement measurement device A of the present embodiment.

The displacement measurement device A includes a measurement coil 1, a correction coil 2, an inductance detection circuit (inductance detection circuits 3 and 4), a temperature detection circuit 5, a calculation circuit 6, an output circuit 7, and a metal object (metal member) M1. Further, the measurement coil 1 and the correction coil 2 constitute a detection unit K.

The inductance detection circuit includes the two inductance detection circuits 3 and 4. The inductance detection circuit 3 is configured to measure an inductance L1 of the measurement coil 1 and the inductance detection circuit 4 is configured to measure an inductance L2 of the correction coil 2.

The temperature detection circuit 5 is configured to measure a temperature of the detection unit K.

The calculation circuit 6 creates a displacement signal according to a relative position of the metal object M1 to the measurement coil 1, based on measurement results (detection results) of the inductance detection circuits 3 and 4 and the temperature detection circuit 5. Note that, the displacement signal according to the relative position means a displacement signal indicative of the relative position, and is, for example, a voltage signal having a voltage value corresponding to the relative position and a current signal having a current value corresponding to the relative position.

The output circuit 7 is configured to convert the displacement signal created by the calculation circuit 6 into a signal in a predetermined form and output the resultant signal to an external device.

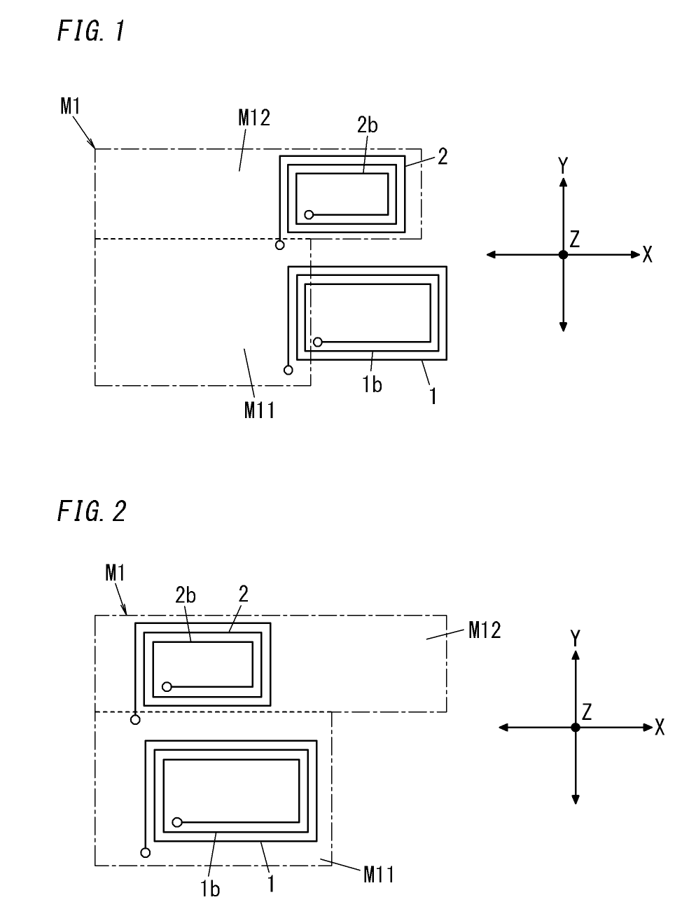

FIG. 1 to FIG. 3 show the arrangement of the measurement coil 1, the correction coil 2, and the metal object M1.

The metal object M1 is formed into a flat plate shape. The metal object M1 is attached to a detection object (not shown). The metal object M1 moves in an X direction (first direction) with a movement of the detection object.

The measurement coil 1 and the correction coil 2 are arranged side by side in a Y direction perpendicular to the X direction. Further, each of the measurement coil 1 and the correction coil 2 is opposite to a moving plane H of the metal object M1 in a Z direction (second direction) respectively perpendicular to the X direction and the Y direction.

Note that, the moving plane H is defined as a moving track surface of the metal object M1 which moves in the X direction. In this regard, the moving track surface is defined as a surface formed by a region which a surface of the metal object M1 opposite to the detection unit K passes through with the movement of the metal object M1. In other words, the metal object M1 is arranged movable in a predetermined moving direction (the first direction, the X direction) within a predetermined moving plane H. Besides, the expression “the metal object M1 moves” means that a relative position of the metal object M1 to the measurement coil 1 (detection unit K) is changed. Accordingly, a situation where the metal object M1 does not move but the measurement coil 1 (detection unit K) moves is also expressed as “the metal object M1 moves”.

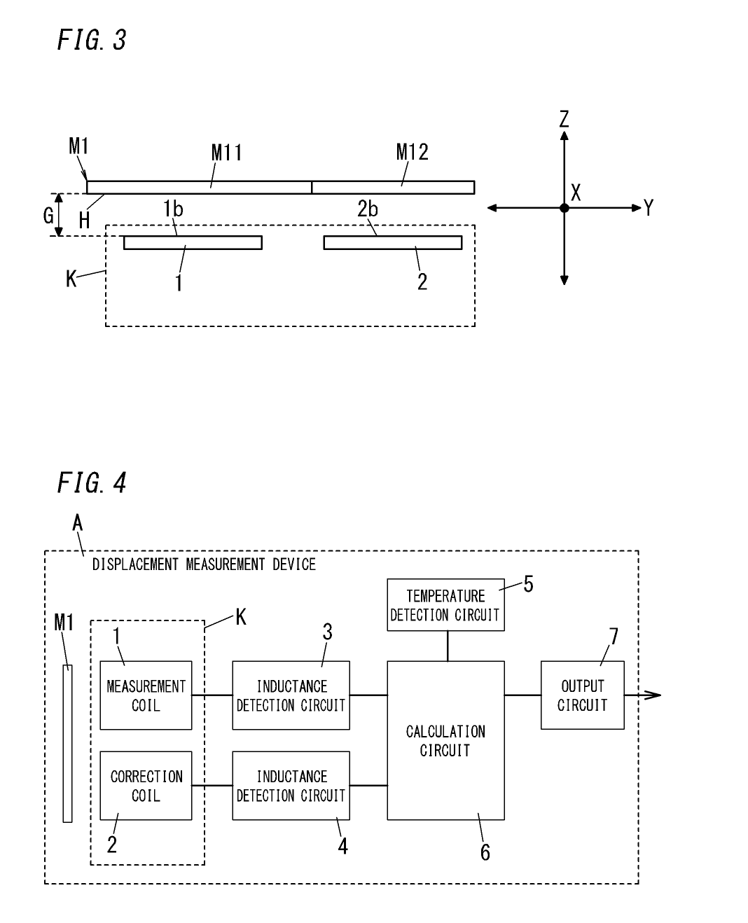

Further, the measurement coil 1 and the correction coil 2 are located at the same position in the Z direction. As seen from FIG. 3, a length (gap length) of a gap between the measurement coil 1 and the metal object M1 in the Z direction and a length (gap length) of a gap between the correction coil 2 and the metal object M1 in the Z direction are equal to G. Thus, a length (gap length) of a gap between the detection unit K and the metal object M1 is equal to G.

In FIG. 1, the metal object M1 is located at a first end (left end, in the figure) in the X direction and in FIG. 2, the metal object M1 is located as a second end (right end, in the figure) in the X direction. Further, in FIG. 1 and FIG. 2, a dimension in the X direction of the correction coil 2 is shorter than a dimension in the X direction of the measurement coil 1, but a relation between the dimensions in the X direction of the measurement coil 1 and the correction coil 2 is not limited to the illustrated instance. For example, the correction coil 2 may have the dimension in the X direction longer than the dimension in the X direction of the measurement coil 1. Alternatively, the measurement coil 1 and the correction coil 2 may have the same dimension in the X direction.

The metal object M1 is provided with a cutout at a side close to the measurement coil 1 of the second end in the X direction. Thus, the metal object M1 includes a region M11 and a region M12. The region M11 is formed into a rectangular shape and is relatively short in the X direction, and the region M12 is formed into a rectangular shape and is relatively long in the X direction. The measurement coil 1 has a coil surface (measurement coil surface, first coil surface) 1b opposite to the moving plane H of the region M11 of the metal object M1 in the Z direction. In other words, the measurement coil 1 has the measurement coil surface (first coil surface) 1b opposite to the moving plane H.

With regard to the coil surface 1b of the measurement coil 1, an opposite area of the coil surface 1b (opposite) to the region M1 is varied with a displacement in the X direction of the metal object M1 (a variation in the relative position of the metal object M1 to the measurement coil 1). In other words, the measurement coil 1 is arranged such that the opposite area (first opposite area) of the measurement coil surface 1b to the moving plane H is varied with the movement of the metal object M1. In this regard, the first opposite area is defined as an area of a region of the measurement coil surface 1b opposite to the metal object M1.

In this case, when the metal object M1 moves toward the first end in the X direction (e.g., the situation shown in FIG. 1), the opposite area of the coil surface 1b of the measurement coil 1 to the region M11 is decreased. In contrast, when the metal object M1 moves toward the second end in the X direction (e.g., the situation shown in FIG. 2), the opposite area of the coil surface 1b of the measurement coil 1 to the region M11 is increased. When the opposite area of the coil surface 1b of the measurement coil 1 to the region M11 is increased, an eddy current flowing through the metal object M1 is increased and thus the inductance L1 is decreased.

Consequently, the inductance L1 of the measurement coil 1 is varied according to the displacement in the X direction of the metal object M1. The movement of the metal object M1 toward the first end in the X direction (e.g., the situation shown in FIG. 1) causes an increase in the inductance L1, and the movement of the metal object M1 toward the second end in the X direction (e.g., the situation shown in FIG. 2) causes a decrease in the inductance L1. Basically, the calculation circuit 6 creates a displacement signal according to the position in the X direction of the metal object M1 (the relative position of the metal object M1 to the measurement coil 1 in the X direction) based on the inductance L1 of the measurement coil 1 measured by the inductance detection circuit 3.

The displacement measurement device A measures the displacement of the metal object M1 by use of a change in the inductance of the measurement coil 1. Hence, a variation in the gap length G between the detection unit K and the metal object M1 is likely to cause an effect on the inductance L1 of the measurement coil 1. For this reason, it is desirable that the gap length G be kept constant.

However, components (e.g., a displacement means for moving the metal object M1 in the X direction not shown) of the displacement measurement device A will suffer from an aged deterioration (e.g., wear). Accordingly, the gap length G may be varied due to such an aged deterioration, and such a variation in the gap length causes an output error in the displacement signal.

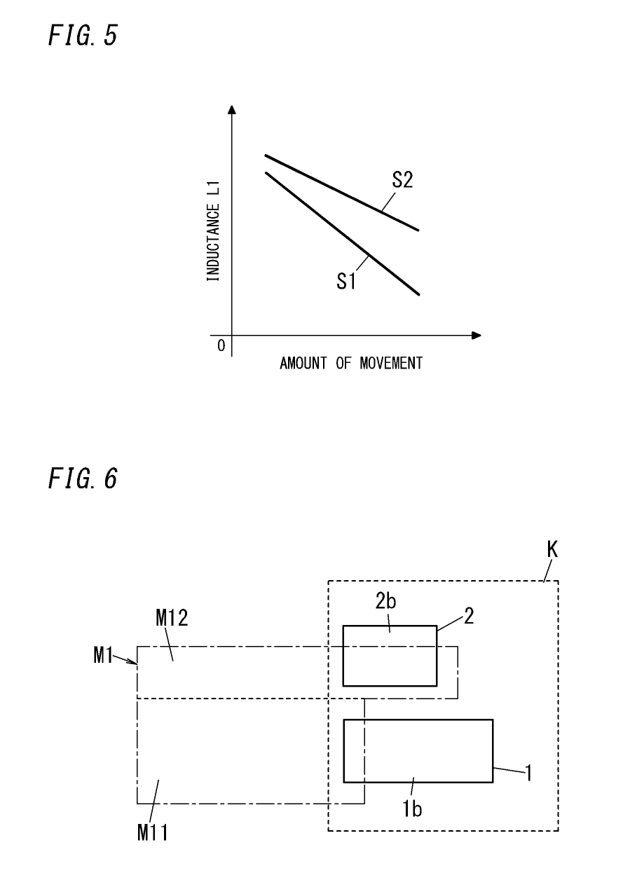

FIG. 5 shows a straight line S1 representing the inductance L1 corresponding to the gap length G of 1 mm, and a straight line S2 representing the inductance L1 corresponding to the gap length G of 2 mm When the gap length G is decreased, a sensitivity of the measurement coil 1 is enhanced. Consequently, the inductance L1 corresponding to the gap length G of 1 mm is lower than the inductance L1 corresponding to the gap length G of 2 mm Such a variation in the inductance L1 due to the gap length G causes the output error in the displacement signal. Note that, when (the position in the X direction of) the metal object M1 moves from the first end in the X direction (left side in FIG. 1 and FIG. 2) to the second end (right side in FIG. 1 and FIG. 2), the inductance L1 is decreased proportional to an amount of the movement of the metal object M1.

In view of the above, to suppress the output error in the displacement even when the gap length G is varied due to the aging deterioration and the like, the displacement measurement device A includes the correction coil 2 in addition to the measurement coil 1.

The correction coil 2 has a coil surface (correction coil surface, second coil surface) 2b opposite to the moving plane H of the region M12 of the metal object M1 in the Z direction. In other words, the correction coil 2 has the correction coil surface (second coil surface) 2b opposite to the moving plane H.

The region M12 of the metal object M1 has a size to cover a whole of the coil surface 2b of the correction coil 2 irrespective of the position of the metal object M1 within the movable range in the X direction. In other words, the whole of the coil surface 2b of the correction coil 2 is always opposite to the region M12 of the metal object M1 within the entire movable range in the X direction of the metal object M1. Consequently, irrespective of the position in the X direction of the metal object M1 (i.e., irrespective of the relative position of the metal object M1 to the measurement coil 1), the opposite area of the coil surface 2b of the correction coil 2 to the region M12 is kept constant. In other words, the correction coil 2 is arranged such that the opposite area (second opposite area) of the correction coil surface 2b to the moving plane H is not varied irrespective of the movement of the metal object M1. In this regard, the second opposite area is defined as an area of a region of the correction coil surface 2b opposite to the metal object M1.

In an ideal instance, the gap length G is not varied and thus the inductance L2 of the correction coil 2 is kept constant irrespective of the position in the X direction of the metal object M1. However, actually, the gap length G is varied and the inductance L2 of the correction coil 2 is also varied. Accordingly, a variation in the gap length G can be measured based on the inductance L2 of the correction coil 2.

Note that, the whole of the coil surface 2b of the correction coil 2 need not be necessarily opposite to the region M12 of the metal object M1. For example, part of the coil surface 2b of the correction coil 2 may be opposite to the region M12 of the metal object M1 (see FIG. 6). In essence, it is sufficient that the opposite area of the coil surface 2b of the correction coil 2 to the region M12 is kept constant irrespective of the position in the X direction of the metal object M1.

Additionally, it is sufficient that the whole or part of the coil surface 1b of the measurement coil 1 is opposite to the moving plane H of the region M11 of the metal object M1.

To reduce the output error due to a variation in the gap length G, the calculation circuit 6 corrects the displacement signal by use of the inductance L2 of the correction coil 2 measured by the inductance detection circuit 4. For example, the calculation circuit 6 generates the displacement signal by means of multiplying the inductance L1 of the measurement coil 1 by a gain α. The gain α is expressed by a function of the inductance L2. Thus, the magnitude of the displacement signal is expressed by L1*α (L2). The gain α (L2) is increased as the inductance L2 is decreased from a reference value (i.e., the gap length G becomes short), and the gain α (L2) is decreased as the inductance L2 is increased from the reference value (i.e., the gap length G becomes long). The reference value is equal to the inductance L2 when the gap length G is identical to a preset value. Accordingly, when the gap length G is less than the preset value, the calculation circuit 6 corrects the displacement signal to increase the magnitude thereof. In contrast, when the gap length G is greater than the preset value, the calculation circuit 6 corrects the displacement signal to decrease the magnitude thereof. Consequently, the displacement measurement device A can reduce the output error due to a variation in the gap between the measurement coil 1 and the metal object M1.

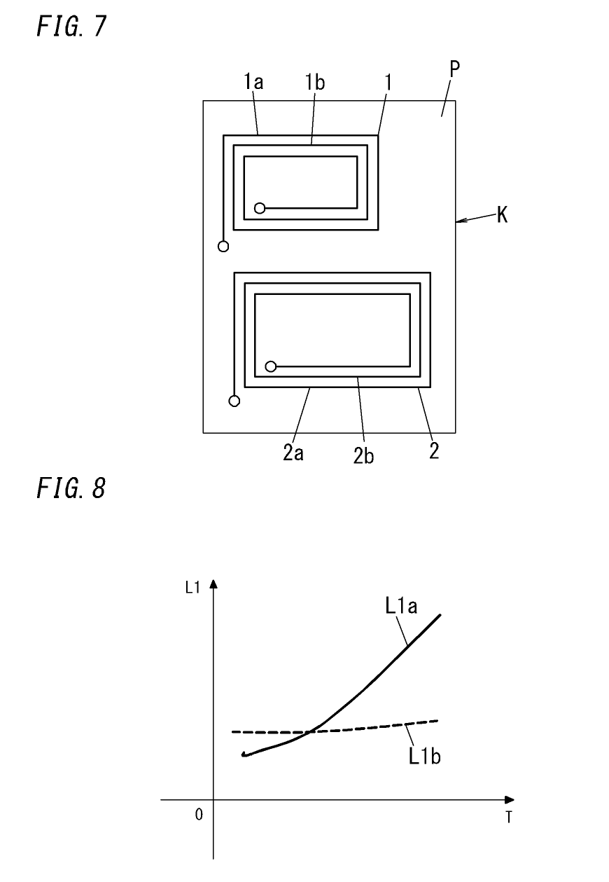

Further, the measurement coil 1 and the correction coil 2 are planar coils. As shown in FIG. 7, the measurement coil 1 and the correction coil 2 are defined by spiral patterned circuits 1a and 2a which are respectively formed on the same printed substrate P. Therefore, the detection unit K can be thinned and be produced at a lowered cost. Moreover, it is possible to form a winding part of a coil at high accuracy. Thus, a deviation of coil characteristics can be reduced.

Furthermore, an increase in a temperature may cause thermal expansion of components of the measurement coil 1 and the correction coil 2, and such thermal expansion may cause an increase in diameters of the patterned circuits 1a and 2a. Hence, the inductances L1 and L2 are likely to be increased. In view of the above, the temperature detection circuit 5 measures a temperature T of the detection unit K, and the calculation circuit 6 performs a correction process of the displacement signal based on the temperature T of the detection unit K.

FIG. 8 shows a relation between the temperature T and the inductance L1. The measured value L1a of the inductance L1 is increased with an increase in the temperature T. The calculation circuit 6 determines a corrective coefficient based on the temperature T of the detection unit K, and multiplies the measured value L1a of the inductance L1 by the corrective coefficient to calculate the temperature correction value L1b for the inductance L1. For example, L1b=L1a*(1+β*T+γ*T²), wherein β denotes a first order corrective coefficient and γ denotes a second order corrective coefficient.

Additionally, the calculation circuit 6 can calculate a temperature correction value for the inductance L2 based on the temperature T of the detection unit K in a similar manner.

The calculation circuit 6 generates the aforementioned displacement signal by use of the temperature correction values for the respective inductances L1 and L2. Through this process, the displacement signal is subjected to the temperature correction. Consequently, the output error due to a variation in the temperature of the detection unit K can be reduced.

Note that, the temperature detection circuit 5 may measure an ambient temperature of the detection unit K. Alternatively, the temperature detection circuit 5 may measure a temperature or an ambient temperature of a part of the displacement measurement device A which is different from the detection unit K. In brief, the temperature detection circuit 5 may be configured to measure the temperature of the displacement measurement device A or the ambient temperature of the displacement measurement device A.

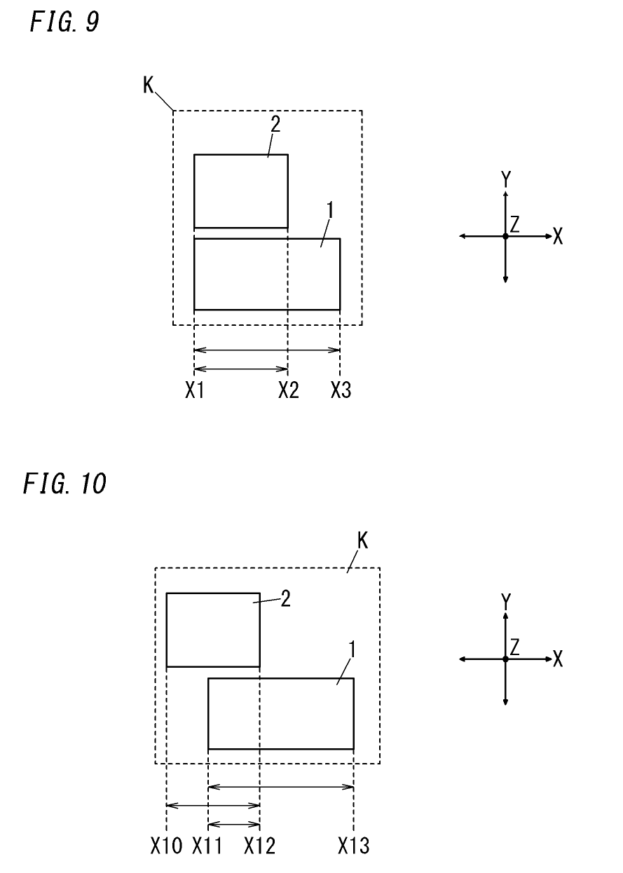

Further, the measurement coil 1 and the correction coil 2 are arranged side by side in the Y direction normal to the moving direction X of the metal object M1. In other words, as shown in FIG. 9, the measurement coil 1 and the correction coil 2 are opposite to each other in the Y direction and are overlapped with each other in the Y direction within a range of X1 to X2 with regard to a coordinate position in the X direction (CONFIGURATION 1). That is to say, the measurement coil 1 and the correction coil 2 are arranged such that the range (range of X1 to X3) occupied by the measurement coil 1 in a coordinate axis (X coordinate axis) extending along the moving direction (the first direction, the X direction) and the range (range of X1 to X2) occupied by the correction coil 2 in the coordinate axis (X coordinate axis) are overlapped with each other.

Therefore, in contrast to an instance where the measurement coil 1 and the correction coil 2 are arranged in the X direction, it is possible to downsize the detection unit K in the X direction. Note that, in FIG. 9, the correction coil 2 is entirely overlapped with the measurement coil 1 in the X direction. In this case, the size of the detection unit K in the X direction can be minimized. Additionally, since the measurement coil 1 and the correction coil 2 are arranged in the Y direction, the coil surface 2b of the correction coil 2 can have an increased area.

Alternatively, as shown in FIG. 10, the correction coil 2 may be partly overlapped with the measurement coil 1 within the range of X11 to X12 with regard to the coordinate position in the X direction of X11 to X12. That is to say, the measurement coil 1 and the correction coil 2 are arranged such that the range (range of X11 to X13) occupied by the measurement coil 1 in a coordinate axis (X coordinate axis) extending along the moving direction (the first direction, the X direction) and the range (range of X10 to X12) occupied by the correction coil 2 in the coordinate axis (X coordinate axis) are overlapped with each other.

Moreover, the coil surface 1b of the measurement coil 1 and the coil surface 2b of the correction coil 2 are not overlapped with each other in the Z direction (CONFIGURATION 2). In other words, the measurement coil 1 and the correction coil 2 are arranged such that the measurement coil surface 1b and the correction coil surface 2b are not overlapped with each other with regard to a plane parallel to the moving plane H. Consequently, a magnetic interference between the measurement coil 1 and the correction coil 2 can be suppressed, and the output accuracy can be improved.

Note that, aforementioned CONFIGURATION 2 can be paraphrased as follows.

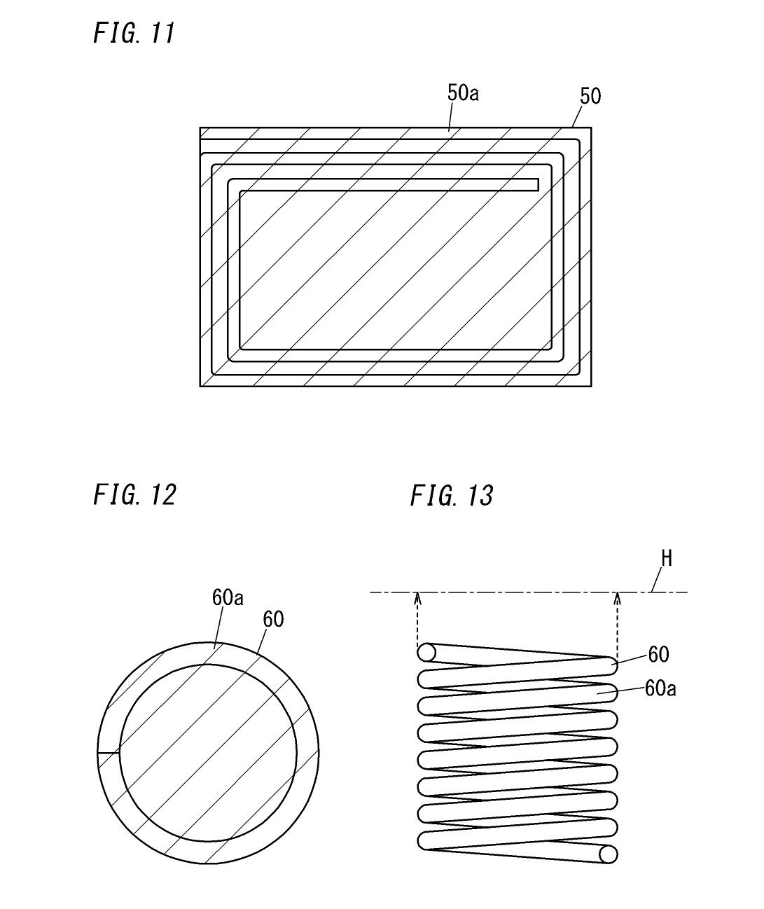

For example, as shown in FIG. 11, a coil surface of a planar coil 50 constituted by a patterned circuit 50a is defined as a plane (illustrated with hatched lines in FIG. 11) surrounded by an outline of the patterned circuit 50a constituting the planar coil 50, and is defined as an effective magnetic flux surface. In brief, the coil surface 1b of the measurement coil 1 constituted by the patterned circuit 1a is defined as a region surrounded by an outline of the patterned circuit 1a, and the coil surface 2b of the correction coil 2 constituted by the patterned circuit 2a is defined as a region surrounded by an outline of the patterned circuit 2a.

Hence, CONFIGURATION 2 can be paraphrased as “when the measurement coil 1 and the correction coil 2 are projected on the moving plane H of the metal object M1 in the Z direction, the coil surfaces 1b and 2b of the measurement coil 1 and the correction coil 2 are not overlapped with each other with regard to projection images produced on the moving plane H”.

Alternatively, winding coils formed by winding copper wire may be used as the measurement coil 1 and the correction coil 2. For example, as shown in FIG. 12 and FIG. 13, a coil surface of a winding coil 60 formed by winding copper wire 60a is defined as a plane (illustrated with hatched lines in FIG. 12) surrounded by an outline of the wound wire 60a with regard to a plane normal to an axial direction of the coil, and is defined as an effective magnetic flux surface. In brief, the coil surface 1b of the measurement coil 1 formed by winding copper wire is defined as a plane surrounded by an outline of the wound copper wire, and the coil surface 2b of the correction coil 2 formed by winding copper wire is defined as a plane surrounded by an outline of the wound copper wire.

Also in this case, in a similar manner as the above, CONFIGURATION 2 can be paraphrased as “when the measurement coil 1 and the correction coil 2 are projected on the moving plane H (see FIG. 12 and FIG. 13) of the metal object M1 in the Z direction, the coil surfaces 1b and 2b of the measurement coil 1 and the correction coil 2 are not overlapped with each other with regard to projection images produced on the moving plane H”.

The measurement coil 1 and the correction coil 2 need not necessarily be disposed in the same position in the Z direction. In brief, the measurement coil 1 and the correction coil 2 may be placed in different positions in the Z direction. In this case, the gap length between the measurement coil 1 and the metal object M1 can be estimated based on the inductance L2 of the correction coil 2 so long as the positional relation between the measurement coil 1 and the correction coil 2 is preliminarily known.

The displacement measurement device A of the present embodiment explained above includes the following first to fourth features. Note that, the second to fourth features are optional. The displacement measurement device A of the present embodiment need not necessarily include all of the second to fourth features, but may include the second to fourth features selectively.

In the first feature, the displacement measurement device A includes: the metal object M1 movable in the first direction (X direction); the measurement coil 1 and the correction coil 2 disposed opposite to the moving plane H of the metal object M1; the inductance detection circuit (inductance detection circuits 3 and 4) configured to detect (measure) the respective inductances L1 and L2 of the measurement coil 1 and the correction coil 2; and the calculation circuit 6 configured to create the displacement signal according to the relative position of the metal object M1 to the measurement coil 1 by use of the detection result (measurement result) from the inductance detection circuit (inductance detection circuits 3 and 4). The coil surface 1b of the measurement coil 1 has the opposite area opposite to the metal object M1 which is varied according to the relative position of the metal object M1. The coil surface 2b of the measurement coil 2 has the opposite area opposite to the metal object M1 which is constant irrespective of the relative position of the metal object M1. The coil surface 1b of the measurement coil 1 and the coil surface 2b of the correction coil 2 are not overlapped with each other in the second direction (Z direction) in which the measurement coil 1 and the correction coil 2 face the moving plane H of the metal body M1. The measurement coil 1 and the correction coil 2 are arranged such that the coordinate positions of the measurement coil 1 and the correction coil 2 in the first direction (X direction) are overlapped with each other.

In other words, the displacement measurement device A includes the metal object M1, the measurement coil 1, the correction coil 2, the inductance detection circuit (inductance detection circuits 3 and 4), and the calculation circuit 6. The metal object M1 is arranged movable in the predetermined moving direction (the first direction, the X direction) within the predetermined moving plane H. The measurement coil 1 has the measurement coil surface (first coil surface) 1b opposite to the moving plane H. The measurement coil 1 is arranged such that the opposite area (first opposite area) of the measurement coil surface 1b to the moving plane H is varied with the movement of the metal object M1. The correction coil 2 has the correction coil surface (second coil surface) 2b opposite to the moving plane H. The correction coil 2 is arranged such that the opposite area (second opposite area) of the correction coil surface 2b to the moving plane H is not varied irrespective of the movement of the metal object M1. The inductance detection circuit (inductance detection circuits 3 and 4) is configured to measure the respective inductances L1 and L2 of the measurement coil 1 and the correction coil 2. The calculation circuit 6 is configured to create the displacement signal according to the relative position of the metal object M1 relative to the measurement coil 1 by use of the measurement result from the inductance detection circuit (inductance detection circuits 3 and 4). The measurement coil 1 and the correction coil 2 are arranged such that the measurement coil surface 1b and the correction coil surface 2b are not overlapped with each other with regard to a plane parallel to the moving plane H but the range occupied by the measurement coil 1 in the coordinate axis (X coordinate axis) extending along the moving direction (the first direction, the X direction) and the range occupied by the correction coil 2 in the coordinate axis (X coordinate axis) are overlapped with each other.

In the second feature, the measurement coil 1 and the correction coil 2 are defined as the patterned circuits 1a and 2a which are formed on the same substrate (printed substrate) P.

In the third feature, the calculation circuit 6 is configured to, based on the measurement result from the inductance detection circuit (inductance detection circuits 3 and 4), generate the displacement signal by means of multiplying the inductance L1 of the measurement coil 1 by the gain and modify the gain according to the inductance L2 of the correction coil 2.

In the fourth feature, the displacement measurement device A further includes the temperature detection circuit 5 configured to measure the temperature of the displacement measurement device A or the ambient temperature of the displacement measurement device A. The calculation circuit 6 is configured to perform the correction process of the displacement signal based on the measurement result from the temperature detection circuit 5.

As mentioned above, the displacement measurement device A of the present embodiment creates the displacement signal by use of the respective inductances L1 and L2 of the measurement coil 1 and the correction coil 2. Hence, the output error due to the variation in the gap between the measurement coil 1 and the metal object M1 can be reduced. Further, in contrast to an instance where the measurement coil 1 and the correction coil 2 are arranged side by side in the first direction (X direction), the detection unit K constituted by the measurement coil 1 and the correction coil 2 can be downsized in the first direction (X direction). In brief, the displacement measurement device A can reduce the detection error due to the variation in the gap between the measurement coil 1 and the metal object M1 and can be downsized in the direction extending along the moving direction (X direction) of the metal object M1.

### Second Embodiment

For example, inclination of the metal object M1 is likely to cause a variation in the gap length between the metal object M1 and the correction coil 2. Hence, an error may occur in the inductance L2 of the correction coil 2.

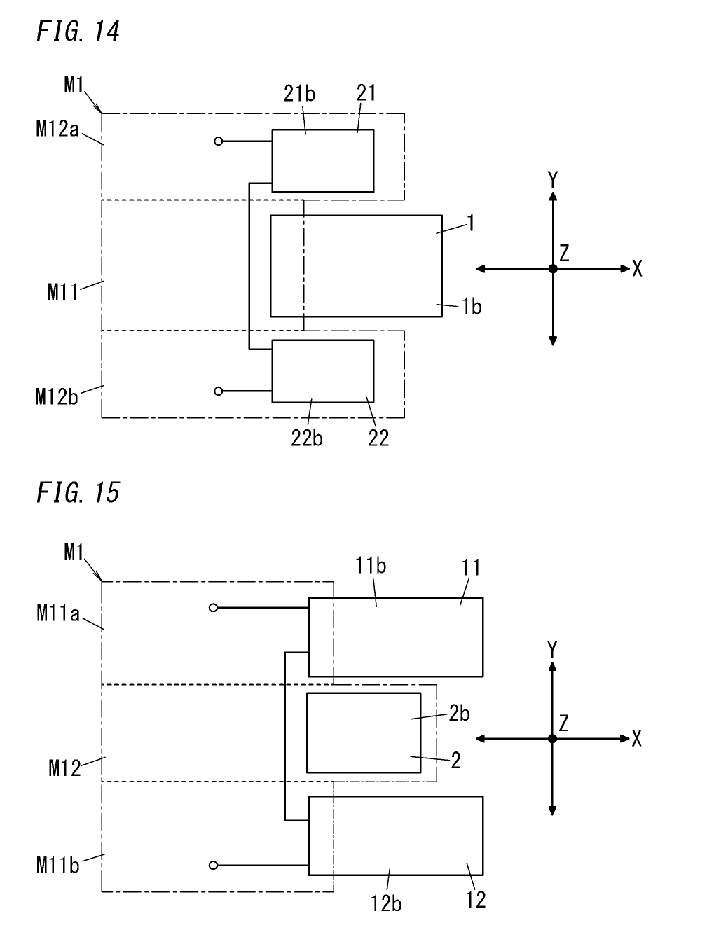

In view of the above, as shown in FIG. 14, the displacement measurement device A of the present embodiment includes the correction coil constituted by paired correction coils 21 and 22 (first and second correction coils) connected in series with each other. In other words, the first correction coil 21 and the second correction coil 22 constitute the correction coil.

The correction coils 21 and 22 are arranged in the Y direction. The measurement coil 1 is interposed between the correction coils 21 and 22. Accordingly, the correction coil 21, the measurement coil 1, and the correction coil 22 are arranged in the Y direction in this order.

The metal object M1 is provided with a cutout at a center part opposite to the measurement coil 1 of the second end in the X direction (right end in FIG. 14). Thus, the metal object M1 includes the region M11 and regions M12a and M12b which are positioned on both sides of the region M11 respectively. The region M11 is formed into a rectangular shape and is relatively short in the X direction. Each of the regions M12a and M12b is formed into a rectangular shape and is relatively long in the X direction. The measurement coil 1 has the coil surface 1b opposite to the moving plane H of the region M11 of the metal object M1 in the Z direction. The correction coil 21 has a coil surface 21b opposite to the moving plane H of the region M12a of the metal object M1 in the Z direction. The correction coil 22 has a coil surface 22b opposite to the moving plane H of the region M12b of the metal object M1 in the Z direction.

The inductance detection circuit 4 is configured to measure an inductance across a series circuit of the correction coils 21 and 22. In other words, the inductance detection circuit 4 measures the sum (L21+L22) of an inductance L21 of the correction coil 21 and an inductance L22 of the correction coil 22.

For example, the metal object M1 is inclined about a rotation axis extending along the X direction, and thus the gap between the metal object M1 and the correction coil 21 is decreased and the gap between the metal object M1 and the correction coil 22 is increased. In this case, the inductance L21 of the correction coil 21 is decreased and the inductance L22 of the correction coil 22 is increased. In contrast, the metal object M1 is inclined about a rotation axis extending along the X direction, and thus the gap between the metal object M1 and the correction coil 21 is increased and the gap between the metal object M1 and the correction coil 22 is decreased. In this case, the inductance L21 of the correction coil 21 is increased and the inductance L22 of the correction coil 22 is decreased.

In brief, when the metal object M1 is inclined about a rotation axis extending along the X direction, variations in the inductance L21 and the inductance L22 cancel each other. Consequently, even if the metal object M1 is inclined about a rotation axis extending along the X direction, the sum (L21+L22) of the inductance L21 and the inductance L22 shows a slight variation and is substantially kept constant. Accordingly, the measurement accuracy for the correction coil can be improved and the output error in the displacement signal can be more reduced.

Moreover, since the paired correction coils 21 and 22 are connected in series with each other, the correction coils 21 and 22 can be treated as a single coil in an electrical sense. Therefore, it is sufficient that the inductance detection circuit 4 measures a combined inductance of the inductances L21 and L22. In contrast to a configuration where the inductances L21 and L22 are measured respectively, the circuit configuration can be simplified.

Alternatively, even when the paired correction coils 21 and 22 are connected in parallel with each other, the same effect can be obtained.

As mentioned above, the displacement measurement device A of the present embodiment includes the following fifth feature in addition to the first feature.

In the fifth feature, the correction coil 1 includes the first correction coil 21 and the second correction coil 22 which are connected in series or in parallel with each other. The measurement coil 1 is interposed between the first correction coil 21 and the second correction coil 22. In other words, the correction coil includes the first correction coil 21 and the second correction coil 22 which are electrically connected with each other. The first correction coil 21 and the second correction coil 22 are arranged in the direction (Y direction) respectively perpendicular to the normal direction (Z direction) of the moving plane H and the moving direction (X direction). The measurement coil 1 is interposed between the first correction coil 21 and the second correction coil 22.

The displacement measurement device A of the present embodiment may include the second to fourth features selectively.

Note that, configurations common to the present embodiment and the first embodiment are designated by the same reference numerals and explanations thereof are deemed unnecessary.

### Third Embodiment

For example, inclination of the metal object M1 is likely to cause a variation in the gap length between the metal object M1 and the measurement coil 1. Hence, an error may occur in the inductance L1 of the measurement coil 1.

In view of the above, as shown in FIG. 15, the displacement measurement device A of the present embodiment includes the measurement coil constituted by paired measurement coils 11 and 12 (first and second measurement coils) connected in series with each other. In other words, the first measurement coil 11 and the second measurement coil 12 constitute the measurement coil.

The measurement coils 11 and 12 are arranged in the Y direction. The correction coil 2 is interposed between the measurement coils 11 and 12. Accordingly, the measurement coil 11, the correction coil 2, and the measurement coil 12 are arranged in the Y direction in this order.

The metal object M1 is provided with a protrusion opposite to the correction coil 2 which extends from the center of the second end in the X direction (right end in FIG. 15). Thus, the metal object M1 includes the region M12 and regions M11a and M11b which are positioned on both sides of the region M12 respectively. The region M12 is formed into a rectangular shape and is relatively long in the X direction, and each of the regions M11a and M11b is formed into a rectangular shape and is relatively short in the X direction. The correction coil 2 has the coil surface 2b opposite to the moving plane H of the region M12 of the metal object M1 in the Z direction. The measurement coil 11 has a coil surface 11b opposite to the moving plane H of the region M11a of the metal object M1 in the Z direction. The measurement coil 12 has a coil surface 12b opposite to the moving plane H of the region M11b of the metal object M1 in the Z direction.

The inductance detection circuit 3 is configured to measure an inductance across a series circuit of the measurement coils 11 and 12. In other words, the inductance detection circuit 3 measures the sum (L11+L12) of an inductance L11 of the measurement coil 11 and an inductance L12 of the measurement coil 12.

For example, the metal object M1 is inclined about a rotation axis extending along the X direction, and thus the gap between the metal object M1 and the measurement coil 11 is decreased and the gap between the metal object M1 and the measurement coil 12 is increased. In this case, the inductance L11 of the measurement coil 11 is decreased and the inductance L12 of the measurement coil 12 is increased. In contrast, the metal object M1 is inclined about a rotation axis extending along the X direction, and thus the gap between the metal object M1 and the measurement coil 11 is increased and the gap between the metal object M1 and the measurement coil 12 is decreased. In this case, the inductance L11 of the measurement coil 11 is increased and the inductance L12 of the measurement coil 12 is decreased.

In brief, when the metal object M1 is inclined about a rotation axis extending along the X direction, variations in the inductance L11 and the inductance L12 cancel each other. Consequently, even if the metal object M1 is inclined about a rotation axis extending along the X direction, the sum (L11+L12) of the inductance L11 and the inductance L12 shows a slight variation and is substantially kept constant. Accordingly, the measurement accuracy for the correction coil can be improved and the output error in the displacement signal can be more reduced.

Moreover, since the paired measurement coils 11 and 12 are connected in series with each other, the measurement coils 11 and 12 can be treated as a single coil in an electrical sense. Therefore, it is sufficient that the inductance detection circuit 3 measures a combined inductance of the inductances L11 and L12. In contrast to a configuration where the inductances L11 and L12 are measured respectively, the circuit configuration can be simplified.

Alternatively, even when the paired measurement coils 11 and 12 are connected in parallel with each other, the same effect can be obtained.

As mentioned above, the displacement measurement device A of the present embodiment includes the following sixth feature in addition to the first feature.

In the sixth feature, the measurement coil includes the first measurement coil 11 and the second measurement coil 12 which are connected in series or in parallel with each other. The correction coil 2 is interposed between the first measurement coil 11 and the second measurement coil 12. In other words, the measurement coil includes the first measurement coil 11 and the second measurement coil 12 which are electrically connected with each other. The first measurement coil 11 and the second measurement coil 12 are arranged in the direction (Y direction) respectively perpendicular to the normal direction (Z direction) of the moving plane H and the moving direction (X direction). The correction coil 2 is interposed between the first measurement coil 11 and the second measurement coil 12.

In addition, the displacement measurement device A of the present embodiment may include the second to fourth features selectively.

Note that, configurations common to the present embodiment and the first embodiment are designated by the same reference numerals and explanations thereof are deemed unnecessary.

### Fourth Embodiment

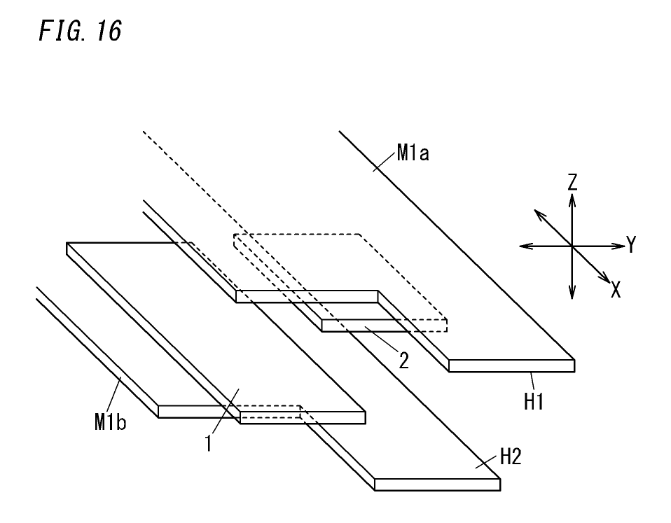

In the present embodiment, as shown in FIG. 16, two metal objects M1a and M1b (first and second metal objects) are attached to the same detection object (not shown). Each of the metal objects M1a and M1b is formed into a flat plate shape. The metal objects M1a and M1b are arranged in the Z direction such that plate surfaces of the respective metal objects M1a and M1b are opposite to each other. In brief, the metal objects M1a and M1b constitute the metal object. The measurement coil 1 and the correction coil 2 are positioned between the plate surfaces of the respective metal objects M1a and M1b.

In this manner, the measurement coil 1 and the correction coil 2 are positioned between the metal objects M1a and M1b. Consequently, the inductance detection circuit 3 can have the improved measurement sensitivity for the inductance L1 of the measurement coil 1 and the inductance detection circuit 4 can have the improved measurement sensitivity for the inductance L2 of the correction coil 2.

As mentioned above, the displacement measurement device A of the present embodiment includes the following seventh feature in addition to the first feature.

In the seventh feature, the metal object includes the first metal object M1a and the second metal object M1b. The measurement coil 1 and the correction coil 2 are interposed between the moving plane H1 of the first metal object M1a and the moving plane 112 of the second metal object M1b. In other words, the metal object includes the first metal object M1a and the second metal object M1b which are arranged opposite to each other. The measurement coil 1 and the correction coil 2 are interposed between the first metal object M1a and the second metal object M1b.

In addition, the displacement measurement device A of the present embodiment may include the second to fourth features selectively.

Note that, configurations common to the present embodiment and the first embodiment are designated by the same reference numerals and explanations thereof are deemed unnecessary.

### Fifth Embodiment

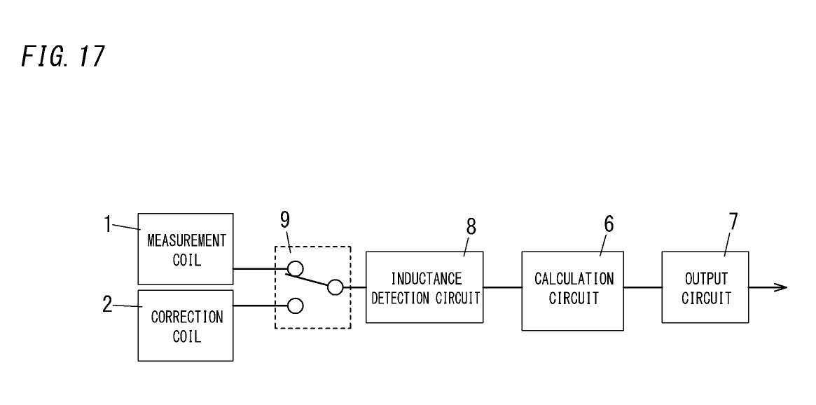

As shown in FIG. 17, the displacement measurement device A of the present embodiment includes an inductance detection circuit 8 and a switch circuit 9 instead of the inductance detection circuits 3 and 4.

The measurement coil 1 and the correction coil 2 are connected to an input (input terminal) 8a of the single inductance detection circuit 8 via the switch circuit 9. The switch circuit 9 switches a destination for the input 8a of the inductance detection circuit 8 between the measurement coil 1 and the correction coil 2. The switching control of the switch circuit 9 is performed depending on a control signal from the inductance detection circuit 8.

In brief, the inductance detection circuit 8 includes the input 8a. The inductance detection circuit 8 is configured to measure an inductance of a coil being connected to the input 8a.

The switch 9 is configured to select one from the measurement coil 1 and the correction coil 2 as a coil connected to the input 8a of the inductance detection circuit 8. For example, the switch 9 selects from the measurement coil 1 and the correction coil 2 the coil connected to the input 8a of the inductance detection circuit 8 according to the control signal from the inductance detection circuit 8.

The inductance detection circuit 8 measures the inductance L1 of the measurement coil 1 and the inductance L2 of the correction coil 2 in a time divisional manner (alternately) by means of switching a destination for the switch circuit 9 between the measurement coil 1 and the correction coil 2, and outputs the resultant inductances to the calculation circuit 6.

Therefore, it is possible to measure the respective inductances L1 and L2 of the measurement coil 1 and the correction coil 2 by use of the single inductance detection circuit 8. In contrast to an instance where the two inductance detection circuits 3 and 4 are used (see FIG. 4), the configuration of the displacement measurement device can be simplified.

As mentioned above, the displacement measurement device A of the present embodiment includes the following eighth feature in addition to the first feature.

In the eighth feature, the inductance detection circuit is constituted by the single inductance detection circuit 8 is configured to measure the inductances L1 and L2 of the measurement coil 1 and the correction coil 2. The displacement measurement device A further includes the switch 9 configured to select the destination for the input 8a of the inductance detection circuit 8 from the measurement coil 1 and the correction coil 2.

In other words, the inductance detection circuit 8 includes the input terminal 8a. The inductance detection circuit 8 is configured to measure an inductance of a coil being connected to the input terminal 8a. The displacement measurement device A includes the switch 9. The switch 9 is configured to select one from the measurement coil 1 and the correction coil 2 as a coil connected to the input terminal 8a of the inductance detection circuit 8.

In addition, the displacement measurement device A of the present embodiment may include the second to fourth features selectively. Moreover, the displacement measurement device A of the present embodiment may include any one of the fifth to seventh features.

### Sixth Embodiment

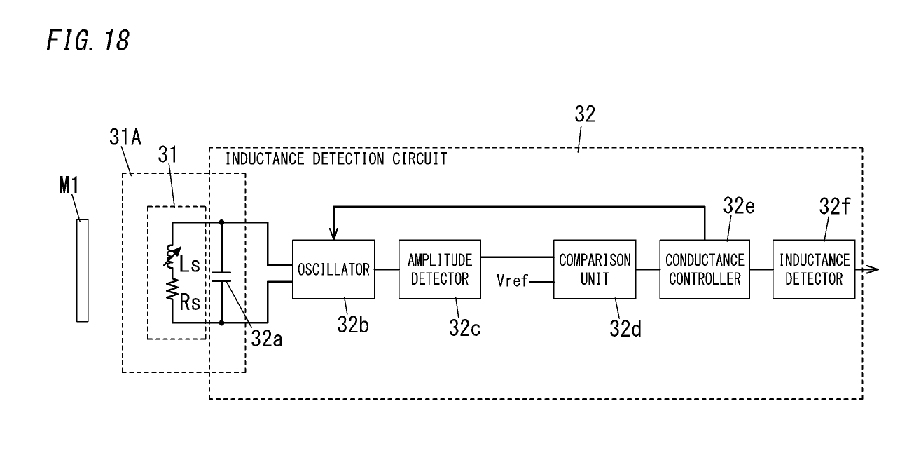

In the present embodiment, inductance measurement functions of the inductance detection circuits 3 and 4 of the first to fourth embodiments and the inductance detection circuit 8 of the fifth embodiment are explained with reference to FIG. 18.

FIG. 18 illustrates a block configuration of an inductance detection circuit 32 configured to measure an inductance of a coil 31. The coil 31 faces the metal object M1. This block configuration can be applied to the inductance detection circuits 3, 4, and 8. Note that, configurations common to the present embodiment and any one of the first to fifth embodiments are designated by the same reference numerals and explanations thereof are deemed unnecessary.

The inductance detection circuit 32 includes a capacitor 32a, an oscillator 32b, an amplitude detector 32c, a comparison unit 32d, a conductance controller 32e, and an inductance detector 32f.

The capacitor 32a is connected in parallel with the coil 31. The coil 31 and the capacitor 32a constitute an LC resonance circuit 31A. In the drawings, the coil 31 is shown as an equivalent circuit which is a series circuit of an inductance component Ls and a resistance component Rs.

The oscillator 32b applies an oscillation voltage to the LC resonance circuit 31A to oscillate the LC resonance circuit 31A.

The LC resonance circuit 31A is kept oscillating by the oscillation voltage applied from the oscillator 32b. In this regard, the coil 31 of the LC resonance circuit 31A has conductance Gc, and the oscillator 32b has negative conductance Gosc. When the conductance Gc of the coil 31 is greater than an absolute value of the negative conductance Gosc of the oscillator 32b, an oscillation condition is not fulfilled Therefore, the oscillation of the LC resonance circuit 31A is terminated. In contrast, when the conductance Gc is less than the absolute value of the negative conductance Gosc, the oscillation condition is fulfilled. Therefore, the oscillation of the LC resonance circuit 31A is kept. When the conductance Gc is approximately equal to the absolute value of the negative conductance Gosc, the LC resonance circuit 31A is in a critical state in which the oscillation condition is just fulfilled.

The amplitude detector 32c measures the oscillation voltage of the LC resonance circuit 31A applied by the oscillator 32b. The comparison unit 32d compares amplitude of the oscillation voltage with a critical value (reference voltage). The conductance controller 32e adjusts the negative conductance Gosc of the oscillator 32b according to a comparison result from the comparison unit 32d to control the amplitude of the oscillation voltage of the LC resonance circuit 31A to be equal to the critical value.

Although the conductance Gc of the coil 31 is varied according to the opposite area to the metal object M1, the conductance controller 32e controls the negative conductance Gosc of the oscillator 32b in accordance with a change in the conductance Gc to maintain the critical state in which the oscillation condition is fulfilled. For example, the conductance controller 32e controls the negative conductance Gosc of the oscillator 32b such that the oscillation voltage is identical to the critical value.

When the amplitude of the oscillation voltage is identical to the critical value, the negative conductance Gosc of the oscillator 32b is approximately equal to the conductance Gc of the LC resonance circuit 31A. Consequently, the inductance detector 32f can measure the inductance component Ls of the coil 31 based on the negative conductance Gosc of the oscillator 32b adjusted by the conductance controller 32e.

For example, Gc=Gosc=C*Rs/Ls (formula (I)), wherein C denotes a capacitance of the capacitor 32a. The inductance detector 32f can calculate the inductance component Ls of the coil 31 by use of the negative conductance Gosc of the oscillator 32b, the capacitance C of the capacitor 32a, the resistance component Rs of the coil 31. Note that, the inductance detector 32f preliminarily stores the capacitance C of the capacitor 32a and the resistance component Rs of the coil 31.

Accordingly, with forming the inductance detection circuit (inductance detection circuits 3 and 4) of the first to fourth embodiments and the inductance detection circuit 8 of the fifth embodiment in a similar manner as the inductance detection circuit 32 shown in FIG. 18, it is possible to measure the inductances of the measurement coil 1 and the correction coil 2. Note that, the inductances of the measurement coils 11 and 12 and the correction coils 21 and 22 also can be measured in a similar manner.

For example, the inductance detection circuit of the first to fourth embodiments includes the two capacitor (first and second capacitors) 32a, the oscillator (first and second oscillators) 32b, the amplitude detector (first and second amplitude detectors) 32c, the comparison unit (first and second comparison units) 32d, the conductance controller (first and second conductance controllers) 32e, and the inductance detector (first and second inductance detectors) 32f.

Concretely, the inductance detection circuit 3 includes the capacitor (first capacitor) 32a, the oscillator (first oscillator) 32b, the amplitude detector (first amplitude detector) 32c, the comparison unit (first comparison unit) 32d, the conductance controller (first conductance controller) 32e, and the inductance detector (first inductance detector) 32f. The capacitor (first capacitor) 32a is connected in parallel with the measurement coil 1. The oscillator (first oscillator) 32b is configured to oscillate the resonance circuit (first resonance circuit) 31A of the measurement coil 1 and the capacitor (first capacitor) 32a. The amplitude detector (first amplitude detector) 32c is configured to measure the oscillation voltages of the resonance circuit (first resonance circuit) 31A. The comparison unit (first comparison unit) 32d is configured to compare the oscillation voltage measured by the amplitude detector (first amplitude detector) 32c with the reference voltage. The conductance controller (first conductance controller) 32e is configured to adjust the negative conductance of the oscillator (first oscillator) 32b based on the comparison result from the comparison unit (first comparison unit) 32d such that the oscillation voltage is equal to the reference voltage. The inductance detector (first inductance detector) 32f is configured to measure the inductance of the measurement coil 1 based on the adjustment result of the negative conductance from the conductance controller (first conductance controller) 32e. The inductance detection circuit 4 includes the capacitor (second capacitor) 32a, the oscillator (second oscillator) 32b, the amplitude detector (second amplitude detector) 32c, the comparison unit (second comparison unit) 32d, the conductance controller (second conductance controller) 32e, and the inductance detector (second inductance detector) 32f. The capacitor (second capacitor) 32a is connected in parallel with the correction coil 2. The oscillator (second oscillator) 32b is configured to oscillate the resonance circuit (second resonance circuit) 31A of the correction coil 2 and the capacitor (second capacitor) 32a. The amplitude detector (second amplitude detector) 32c is configured to measure the oscillation voltages of the resonance circuit (second resonance circuit) 31A. The comparison unit (second comparison unit) 32d is configured to compare the oscillation voltage measured by the amplitude detector (second amplitude detector) 32c with the reference voltage. The conductance controller (second conductance controller) 32e is configured to adjust the negative conductance of the oscillator (second oscillator) 32b based on the comparison result from the comparison unit (second comparison unit) 32d such that the oscillation voltage is equal to the reference voltage. The inductance detector (second inductance detector) 32f is configured to measure the inductance of the correction coil 2 based on the adjustment result of the negative conductance from the conductance controller (second conductance controller) 32e.

In brief, with regard to the inductance detection circuit 3, the measurement coil 1 is connected to the capacitor 32a as the coil 31. Further, with regard to the inductance detection circuit 4, the correction coil 2 is connected to the capacitor 32a as the coil 31.

For example, the inductance detection circuit 8 of the fifth embodiment includes the single capacitor 32a, the single oscillator 32b, the single amplitude detector 32c, the single comparison unit 32d, the single conductance controller 32e, and the single inductance detector 32f. In the inductance detection circuit 8 of the present embodiment, the capacitor 32a is connected to the measurement coil 1 and the correction coil 2 selectively through the switch 9. When the capacitor 32a is connected to the measurement coil 1 via the switch 9, the inductance detection circuit 8 functions as the inductance detection circuit 3 for measuring the inductance L1 of the measurement coil 1. When the capacitor 32a is connected to the correction coil 2 via the switch 9, the inductance detection circuit 8 functions as the inductance detection circuit 4 for measuring the inductance L2 of the correction coil 2.

In brief, with regard to the inductance detection circuit 8 of the fifth embodiment, the capacitor 32a serves as the first and second capacitors 32a, and the oscillator 32b serves as the first and second oscillators 32b, and the amplitude detector 32c serves as the first and second amplitude detectors 32c, and the comparison unit 32d serves as the first and second comparison units 32d, and the conductance controller 32e serves as the first and second conductance controllers 32e, and the inductance detector 32f serves as the first and second inductance detectors 32f.

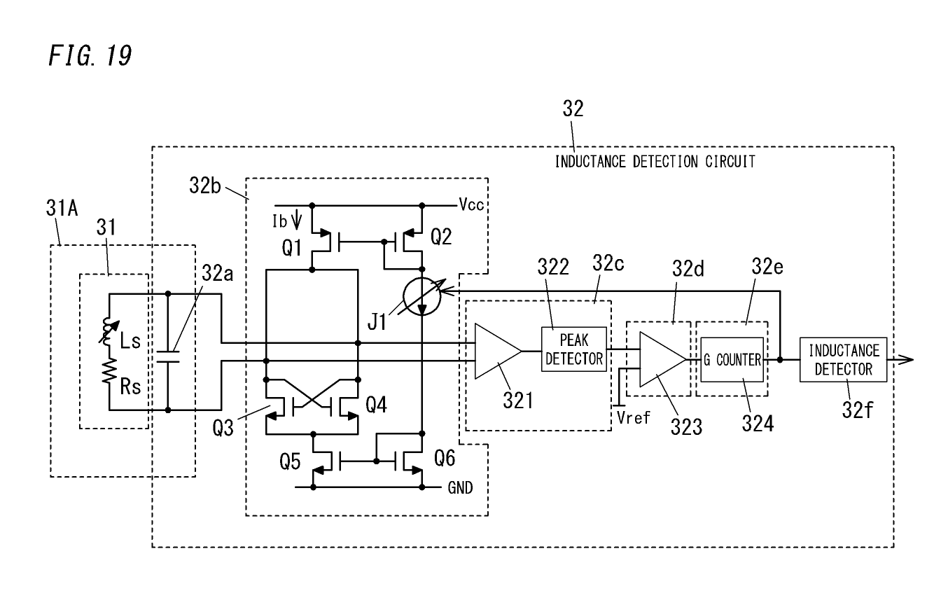

FIG. 19 shows a concrete circuit of the inductance detection circuit 32.

First, the oscillator 32b includes switching elements Q1 and Q2 which are p-type MOSFETs, switching elements Q3 to Q6 which are n-type MOSFETs, and a variable current source J1.

The paired switching elements Q1 and Q2 have sources receiving a DC control voltage Vcc and gates connected to each other. Further, the gate and the drain of the switching element Q2 are short-circuited to each other. The paired switching elements Q1 and Q2 constitute a current mirror circuit. Moreover, the paired switching elements Q5 and Q6 have sources grounded and gates connected to each other. Further, the gate and the drain of the switching element Q6 are short-circuited to each other. The paired switching elements Q5 and Q6 constitute a current mirror circuit. In addition, the paired switching elements Q3 and Q4 are connected in a cross-coupled manner in which a gate of one of the switching elements Q3 and Q4 is connected to a drain of the other.

The paired switching elements Q3 and Q4 have their drains connected to the drain of the switching element Q1 and their sources connected to the drain of the switching element Q5. Further, the variable current source J1 is connected between the drains of the switching elements Q2 and Q6. The LC resonance circuit 31A is connected between the drains of the switching elements Q3 and Q4.

Owing to the current mirror circuits, a DC bias current Ib flowing through the switching element Q1 has the same magnitude as that of a supplied current from the variable current source J1. To keep oscillating the LC resonance circuit 31A, a time period in which the switching element Q3 is kept turned on and a time period in which the switching element Q4 is kept turned on are repeated alternately at an oscillation frequency.

Next, the amplitude detector 32c includes a differential amplifier 321 and a peak detector 322. The differential amplifier 321 has inputs connected to the respective drains of the switching elements Q3 and Q4. The differential amplifier 321 outputs a difference between drain voltages of the respective switching elements Q3 and Q4. The peak detector 322 measures a peak value of amplitude of an output from the differential amplifier 321 so as to measure the amplitude of the oscillation voltage of the LC resonance circuit 31A.

Next, the comparison unit 32d includes a comparator 323 and is configured to compare the amplitude of the oscillation voltage with the reference voltage Vref.

Next, the conductance controller 32e includes a G counter 324 which is constituted by a counter. The G counter 324 is configured to, upon acknowledging, based on the comparison result from the comparator 323, that the amplitude of the oscillation voltage is greater than the reference voltage Vref, increment a counted value by one. The G counter 324 is configured to, upon acknowledging, based on the comparison result from the comparator 323, that the amplitude of the oscillation voltage is less than the reference voltage Vref, decrement the counted value by one. The G counter 324 is configured to provide the counted value to the variable current source J1 so as to adjust the supplied current (substantially equal to the DC bias current Ib) from the variable current source J1.

The variable current source J1 varies the supplied current according to the counted value of the G counter 324, thereby varying the DC bias current Concretely, when the counted value is small (the amplitude of the oscillation voltage is less than the reference voltage Vref), the variable current source J1 increases the DC bias current Ib so as to increase the absolute value of the negative conductance Gosc, thereby increasing the amplitude of the oscillation voltage. In contrast, when the counted value is large (the amplitude of the oscillation voltage is greater than the reference voltage Vref), the variable current source J1 decreases the DC bias current Ib so as to decrease the absolute value of the negative conductance Gosc, thereby decreasing the amplitude of the oscillation voltage. Thus, feedback control of adjusting the amplitude of the oscillation voltage to the reference voltage Vref is performed based on the counted value of the G counter 324. Note that, the negative conductance Gosc of the oscillator 32b is proportional to a square root of the DC bias current Ib.

The counted value of the G counter 324 is corresponding to the negative conductance Gosc. The inductance detector 32f can measure the negative conductance Gosc based on the counted value of the G counter 324. Further, the inductance detector 32f preliminarily stores data indicative of the capacitance C of the capacitor 32a and data indicative of the resistance component Rs of the coil 32. Consequently, the inductance detector 32f can calculate the inductance component Ls of the coil 31 based on the negative conductance Gosc of the oscillator 32b, the capacitance C of the capacitor 32, and the resistance component Rs of the coil 31, by use of the aforementioned formula (I).

As mentioned above, the displacement measurement device A of the present embodiment includes the following ninth feature in addition to the first feature.

In the ninth feature, the inductance detection circuit (3, 4, 8) includes: the capacitors 32a connected in parallel with the measurement coil 1 and the correction coil 2, respectively; the oscillator 32b configured to oscillate the resonance circuit 31A of the measurement coil 1 and the capacitor 32a connected to the measurement coil 1 and the resonance circuit 31A of the correction coil 2 and the capacitor 32a connected to the correction coil 2; the amplitude detector 32c configured to measure the oscillation voltages of the respective resonance circuits 31A; the comparison unit 32d configured to compare the oscillation voltage measured by the amplitude detector 32c with the reference voltage; the conductance controller 32e configured to adjust the negative conductance of the oscillator 32b based on the comparison result from the comparison unit 32d such that the oscillation voltage is equal to the reference voltage; and the inductance detector 32f configured to measure the inductances L1 and L2 of the measurement coil 1 and the correction coil 2 based on the adjustment result of the negative conductance from the conductance controller 32e.

In addition, the displacement measurement device A of the present embodiment may include the second to fourth and eighth features selectively. Moreover, the displacement measurement device A of the present embodiment may include any one of the fifth to seventh features.

### Seventh Embodiment

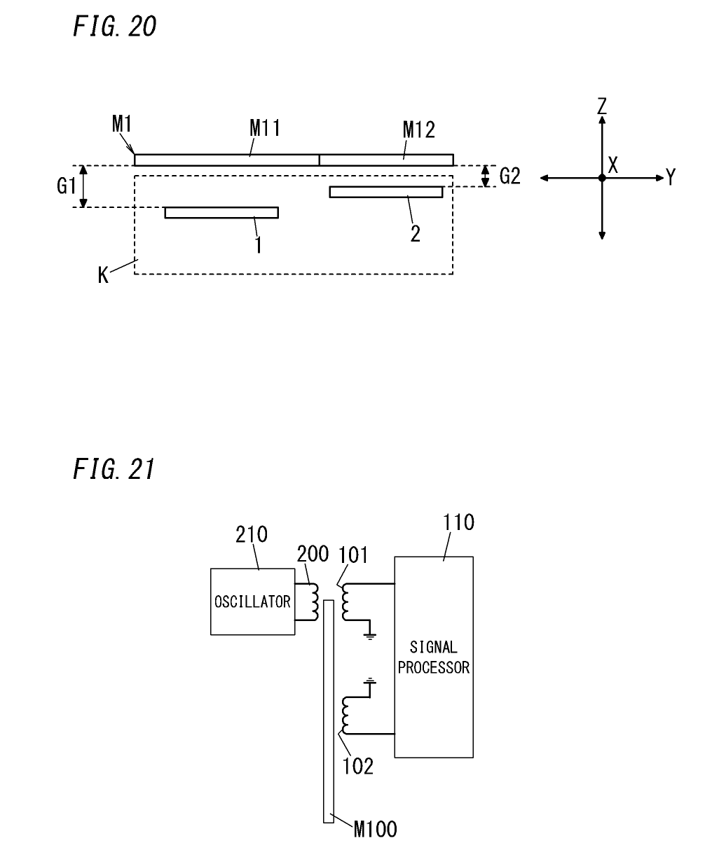

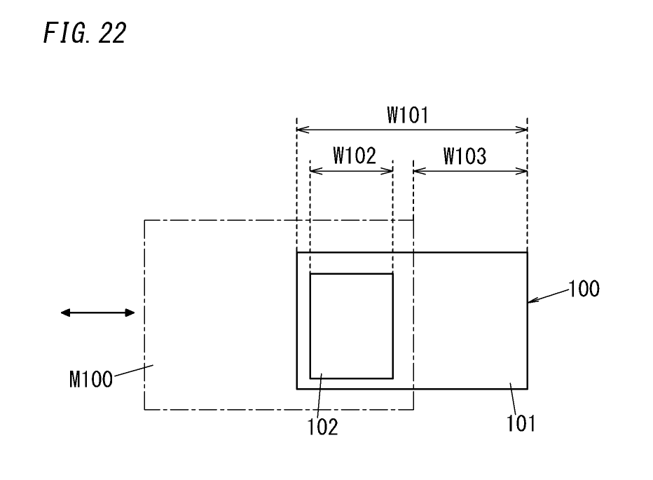

In the first to sixth embodiments, as shown in FIG. 20, the correction coil 2 may be closer to the moving plane H of the metal object M1 than the measurement coil 1 is. In this regard, when the gap length between the measurement coil 1 and the metal object M1 is denoted by G1 and the gap length between the correction coil 2 and the metal object M1 is denoted by G2, G1>G2.

In this case, with placing the correction coil 2 in a position adjacent to the metal object M1 in the Z direction, it is possible to measure a change in the gap length at high accuracy and to more reduce the output error in the displacement signal. Especially, when the size of the correction coil 2 is reduced to downsize the displacement measurement device A, the gap length measurement accuracy for the correction coil 2 is likely to be decreased. To compensate for a decrease in this accuracy, it is effective to place the correction coil 2 in a position adjacent to the metal object M1.

As mentioned above, the displacement measurement device A of the present embodiment includes the following tenth feature in addition to the first feature.

In the tenth feature, the correction coil 2 is closer to the moving plane H of the metal object M1 than the measurement coil 1 is. In other words, a distance (gap length G2) between the correction coil surface (second coil surface) 2b and the moving plate H is shorter than a distance (gap length G1) between the measurement coil surface (first coil surface) 1b and the moving plate H.

In addition, the displacement measurement device A of the present embodiment may include the second to fourth, eighth, and ninth features selectively. Moreover, the displacement measurement device A of the present embodiment may include any one of the fifth to seventh features.

1. A displacement measurement device comprising:
a metal object arranged movable in a predetermined moving direction within a predetermined moving plane;
a measurement coil having a measurement coil surface opposite to the moving plane and arranged such that an opposite area of the measurement coil surface to the moving plane is varied with a movement of the metal object;
a correction coil having a correction coil surface opposite to the moving plane and arranged such that an opposite area of the correction coil surface to the moving plane is not varied irrespective of the movement of the metal object;
an inductance detection circuit configured to measure respective inductances of the measurement coil and the correction coil; and
a calculation circuit configured to create a displacement signal according to a relative position of the metal object relative to the measurement coil by use of a measurement result from the inductance detection circuit,
wherein
the measurement coil and the correction coil are arranged such that the measurement coil surface and the correction coil surface are not overlapped with each other with regard to a plane parallel to the moving plane but a range occupied by the measurement coil in a coordinate axis extending along the moving direction and a range occupied by the correction coil in the coordinate axis are overlapped with each other.

2. The displacement measurement device as set forth in claim 1, wherein
the correction coil includes a first correction coil and a second correction coil which are electrically connected with each other,
the first correction coil and the second correction coil are arranged in a direction respectively perpendicular to a normal direction of the moving plane and the moving direction, and
the measurement coil is interposed between the first correction coil and the second correction coil.

3. The displacement measurement device as set forth in claim 1, wherein
the measurement coil includes a first measurement coil and a second measurement coil which are electrically connected with each other,
the first measurement coil and the second measurement coil are arranged in a direction respectively perpendicular to a normal direction of the moving plane and the moving direction, and
the correction coil is interposed between the first measurement coil and the second measurement coil.

4. The displacement measurement device as set forth in claim 1, wherein
the metal object includes a first metal object and a second metal object which are arranged opposite to each other, and
the measurement coil and the correction coil are interposed between the first metal object and the second metal object.

5. The displacement measurement device as set forth in claim 1, wherein
the inductance detection circuit is constituted by a single inductance detection circuit which is configured to measure the inductances of the measurement coil and the correction coil, and
the displacement measurement device further comprises a switch configured to select a destination for an input of the inductance detection circuit from the measurement coil and the correction coil.

6. The displacement measurement device as set forth in claim 1, wherein
the measurement coil and the correction coil are defined as patterned circuits which are formed on the same substrate.

7. The displacement measurement device as set forth in claim 1, wherein
the inductance detection circuit includes:
capacitors connected in parallel with the measurement coil and the correction coil, respectively;
an oscillator configured to oscillate an resonance circuit of the measurement coil and the capacitor connected to the measurement coil and an resonance circuit of the correction coil and the capacitor connected to the correction coil;
an amplitude detector configured to measure oscillation voltages of the respective resonance circuits;
a comparison unit configured to compare the oscillation voltage measured by the amplitude detector with a reference voltage;
a conductance controller configured to adjust negative conductance of the oscillator based on a comparison result from the comparison unit such that the oscillation voltage is equal to the reference voltage; and
inductance detector configured to measure the inductances of the measurement coil and the correction coil based on an adjustment result of the negative conductance from the conductance controller.

8. The displacement measurement device as set forth in claim 1, wherein
the calculation circuit is configured to, based on the measurement result from the inductance detection circuit, generate the displacement signal by means of multiplying the inductance of the measurement coil by a gain and modify the gain according to the inductance of the correction coil.

9. The displacement measurement device as set forth in claim 1, wherein
the displacement measurement device further comprises a temperature detection circuit configured to measure a temperature of the displacement measurement device or an ambient temperature of the displacement measurement device, and
the calculation circuit is configured to perform a correction process of the displacement signal based on a measurement result from the temperature detection circuit.

10. The displacement measurement device as set forth in claim 1, wherein
the correction coil is closer to the moving plane of the metal object than the measurement coil is.
